(19) United States
(12) Patent Application Publication
(10) Pub. No.: US 2016/0376833 A1
(43) Pub. Date: Dec. 29, 2016

(54) Louver Assembly

(71) Applicant: Levolux Limited, Middlesex (GB)

(72) Inventor: Peter Braybrook, Gloucestershire (GB)

(21) Appl. No.: 15/187,778

(22) Filed: Jun. 21, 2016

(30) Foreign Application Priority Data
Jun. 25, 2015 (GB) 1511227.9

(51) Int. Cl. E06B 7/082; E04F 10/00

(52) U.S. Cl. CPC E06B 7/082; E04F 10/00

(57) ABSTRACT

A louver assembly for an exterior of a building, the assembly comprising: a louver carrier; a louver which is supportable by the louver carrier; and a locking mechanism, means or connector adapted to prevent or limit separation of the louver from the louver carrier The locking connector includes a deflectable first engagement element on one of the louver and the louver carrier, a second engagement element on the other of the louver and the louver carrier and which is engagable with the deflectable first engagement element, and a locking element adapted to prevent or limit movement of the deflectable first engagement element thereby preventing or inhibiting separation of the first and second engagement elements when interconnected.

### CROSS REFERENCE TO RELATED APPLICATION

This application claims priority of British Patent Application No. 1511227.9 filed on Jun. 25, 2015, the entire content of which is hereby incorporated by reference.

### TECHNICAL FIELD

The present invention relates to a louver assembly which enables preferably tool-less assembly. As such, the assembly preferably does not require screw-threaded fasteners, such as bolts or screws, in order to be assembled and to be held rigidly together. The invention further relates to a method of assembling such a louver assembly, and to a louver, louver carrier and, preferably tool-less, locking element forming part of the louver assembly. Optionally, the invention also relates to a method of aligning louvers in series in a louver assembly, to a method of toollessly interconnecting a louver member and a louver carrier with or without a bracket interposed therebetween, and to a method of interconnecting a louver member and a louver carrier using a slidable push-fit locking element.

### BACKGROUND

Louver assemblies are known, and are frequently used on the exterior of buildings to prevent or limit incident solar energy on windows. Louvers are known which are supported at their lateral ends, and which can also be supported along their edge lengths.

However, in all cases, to attach the louvers to their louver carriers, typically formed as vertical support mullions or horizontal transoms, brackets and fasteners are used, which, if visible, can diminish the aesthetic appeal of the louver. Hiding the brackets and fasteners can therefore make installation of a louver assembly more difficult, as it becomes challenging to insert the tools required for installation into the confined spaces around the louver.

It is an object of the present invention to provide a cost-effective and easily installed louver assembly which negates the requirement for cumbersome installation tools.

### SUMMARY

According to a first aspect of the invention there is provided an exterior louver assembly preferably for an exterior of a building, the assembly comprising: a louver carrier; a louver which is supportable by the louver carrier; and locking mechanism, means or connector adapted to limit or prevent separation of the louver relative to the louver carrier, the locking connector including a deflectable first engagement element on one of the louver and the louver carrier, a second engagement element on the other of the louver and the louver carrier and which is engagable with the deflectable first engagement element, and a locking element adapted to prevent or limit deflection of the deflectable first engagement element thereby preventing or inhibiting separation of the first and second engagement elements when interconnected.

By providing engagement between the louver carrier and louver member which operates by forcing at least one deflectable engagement element into a locked configuration, it is possible to entirely remove the requirement for at least screw-threaded fasteners, and potentially also a bracket. The locking element can then be inserted so as to abut the engaged louver carrier and louver member, applying the necessary retaining force, either in a tight push-fit or as a wedge, to prevent dislocation of the louver carrier and louver member. This advantageously simplifies installation of the louver assembly, since there are no awkward screw-threaded fasteners or clips.

In a preferred embodiment, the deflectable first engagement element may be provided on the louver, with the second engagement element being provided on the louver carrier. Said louver may include an elongate louver member, the deflectable first engagement element being provided at a longitudinal edge of the louver member.

By providing a deflectable engagement element on the louver rather than on the louver carrier, the louver can be readily inserted or clipped into the louver carrier for a simple installation procedure, typically via the rear longitudinal edge as viewed, thereby reducing the time taken to install such a louver assembly.

The louver may further include an elongate cap element by which a longitudinal edge of the louver member is coverable.

Cap elements, typically positioned on the rear of the louver member, can be used to alter the aesthetic appeal of the louver as a whole, and can be used to change the shape of the louver. However, they also enable the internal components of the louver to be hidden from view, advantageously hiding the unsightly locking element. A lateral cross-sectional shape or profile of the louver member, being the louver body and cap element combined, may be elliptical or aerofoil shaped, or a box-section, for example.

The louver may include two said deflectable first engagement elements, the two said deflectable first engagement elements being deflectable towards one another during engagement with the second engagement element or elements. Preferably, the locking element may be receivable between the two said deflectable first engagement elements. Alternatively, the louver may include one said deflectable first engagement element and one opposing non-deflectable engagement element, the deflectable first engagement element being deflectable towards the non-deflectable engagement element during engagement with the second engagement element or elements.

By providing a locking element which can be received within the louver member, it can be effectively hidden from view, creating an aesthetically pleasing visual appeal for the assembly. The hiding of the locking element could involve a total enveloping of the locking element, or could simply be hiding of the locking element from certain viewing directions, in particular but not exclusively, from ground level. Furthermore, as the locking element is receivable inside the louver member, installation of the assembly is reduced to sliding mutually co-operating components into engagement with one another.

By providing two deflectable engagement elements, the louver can be readily and quickly engaged with its corresponding louver carrier. It is possible, however, to provide a single deflectable engagement element which is deflectable towards a non-deflectable first engagement element, and achieve the same end result.

In an alternative embodiment, the deflectable first engagement element may be provided on the louver carrier, with the second engagement element being provided on the louver. Preferably, the deflectable first engagement element and the second engagement element may be complementarily shaped, the deflectable first engagement element being receivable within the second engagement element.

It will be apparent that the louver could readily be clipped onto a deflectable engagement element of the louver carrier; this arrangement may further simplify the assembly of a louver assembly.

The louver carrier may include a support mullion or transom, and/or may include a support bracket to which the louver is directly attachable via the locking connector.

The louver- and carrier-engagement portions need not necessarily be integrally formed as part of the louver carrier and louver member respectively; a dedicated bracket could be utilised to provide the interengagement between the louver carrier and louver member whilst still utilising the described locking of deflectable engagement elements to connect the two.

The locking element may comprise a rigid body portion which in use abuttably engages with and limits deflection of the deflectable first engagement element.

The locking element should be beneficially shaped so as to most readily achieve the necessary abutment to deflect the deflectable first engagement elements into a locked condition.

Preferably, the locking element may further comprise a spacer, and wherein the louver assembly comprises a plurality of said louvers, the spacer of the locking element in use may define a separation between adjacent louvers. The spacer may preferably be a cantilevered tang.

The locking element can advantageously provide a way of separating adjacent louvers, to provide a uniform and aesthetically pleasing frontage for the louver assembly.

Optionally, the locking element may further comprise a carrier stop, the carrier stop abutting the louver carrier to limit displacement of the locking element relative to the louver carrier.

Again, the locking element is able to create an aesthetically appealing frontage by securing a well-defined position relative to the louver carrier, to thereby ensure a correct and even relative positioning of the louver carrier(s) and louver(s) of the louver assembly.

The locking element may be formed from a different material to that of the louver member and/or louver carrier.

The louver and perhaps louver carrier should have a uniform visual appeal, and therefore will typically be formed from the same material, usually a light metal such as aluminium. However, the locking member, being hidden from view by an elongate cap element engaged with the louver body along its rear edge, may be formed from a more lightweight or more cost-effective material, such as a plastics material, without altering the overall appearance of the louver assembly. It will be apparent that the locking element could be formed from the same material as the other components, or the louver and louver carrier could be formed from different materials. Aluminium may, for instance, be the most compatible material from which to form the locking element.

In one alternative embodiment, the locking element may comprise an elongate bar receivable within the louver at or adjacent the deflectable first engagement element, which may extend substantially across or along the longitudinal extent of the louver.

A simpler form of locking element may be preferred, such an elongate bar which physically fills all of the available space at or adjacent to the engagement interface, preventing unintentional separation of the louver and louver carrier.

According to a second aspect of the invention, there is provided a method of assembling a louver assembly, the method comprising the steps of: providing an exterior louver assembly, preferably in accordance with the first aspect of the invention; engaging the locking connector of the louver assembly such that the deflectable first engagement element is engaged with the second engagement element; and inserting the locking element at or adjacent to the deflectable first engagement element to prevent or limit deflection of the deflectable first engagement element, thereby preventing or limiting separation of the deflectable first engagement element and the second engagement element.

Engagement between a louver and louver carrier which relies on at least one physically deflected engagement element, as opposed to using fasteners, to secure a louver assembly together, reduces the complexity of the installation process, whilst also reducing the number of components which need to be manufactured to form the assembly.

Preferably, the locking element may be inserted so as to be receivable at least in part within the louver.

According to a third aspect of the invention, there is provided a louver for use in a louver assembly, preferably in accordance with the first aspect of the invention, the louver comprising: an elongate louver member body having at least one deflectable carrier-engagement element at or adjacent to a longitudinal edge thereof; the or each deflectable carrier-engagement element being directly engagable with a complementarily-shaped louver-engagement element of a louver carrier.

Preferably, two said deflectable carrier-engagement elements may be provided, the deflectable carrier-engagement elements being deflectable towards one another. Furthermore, the in use locking element of the locking connector may be at least in part hideable from view within the louver.

According to a fourth aspect of the invention, there is provided a louver carrier for use in a louver assembly, preferably in accordance with the first aspect of the invention, the louver carrier comprising: a carrier body; and a louver-engagement element formed in the carrier body, the louver-engagement element being directly engagable with a carrier-engagement element of a louver.

Preferably, the carrier body is formed as a support mullion or transom.

According to a fifth aspect of the invention, there is provided a locking element for use in a louver assembly, preferably in accordance with the first aspect of the invention, the locking element comprising: a body portion; a carrier stop attached to the body portion to in use define a relative position of a louver carrier engaged therewith; and a spacer, the spacer projecting outside of a volumetric envelope of the body portion in an unlocked configuration to in use define a separation between adjacent louvers engaged therewith.

According to a sixth aspect of the invention, there is provided a method of aligning louvers in series in a louver assembly, preferably in accordance with the first aspect of the invention, the method comprising the steps of: engaging the or each deflectable carrier-engagement element of the first louver with the louver-engagement element of the louver carrier; inserting the locking element between the or each deflectable carrier-engagement element of the first louver such that the carrier stop engages with the louver carrier; and engaging the or each deflectable carrier-engagement element of the second louver with the louver-engagement element of the louver carrier such that the first and second louvers are aligned with one another and supported by the louver carrier.

Preferably, the spacer of the locking element may be positioned between the first and second louvers whereby the first and second louvers are symmetrically positionable about a centre of the louver carrier.

According to a seventh aspect of the invention there is provided a method of assembling a louver assembly, the method comprising the steps of: providing an exterior louver assembly; engaging a locking mechanism of the louver assembly such that a deflectable first engagement element of a louver or louver carrier of the assembly is engaged with a second engagement element of the other of the louver or louver carrier; and inserting a locking element at or adjacent to the deflectable first engagement element to prevent or limit deflection of the deflectable first engagement element, thereby preventing or limiting separation of the deflectable first engagement element and the second engagement element.

According to an eighth aspect of the invention, there is provided an exterior louver assembly, the assembly comprising: a louver carrier which extends from an exterior of a building adjacent to one or more glass panels; a louver which is supportable by the louver carrier; and a locking mechanism which prevents or limits separation of the louver from the louver carrier, wherein the locking mechanism includes at least two vertically spaced-apart deflectable first engagement elements integrally formed as part of the louver, two vertically spaced-apart non-parallel second engagement elements on the louver carrier and by which the deflectable first engagement elements are push-fit engagable therewith, and a separate locking element which is slidably interposable between the deflectable first engagement elements to prevent or limit deflection of the deflectable first engagement elements, so that horizontal extraction of the louver from engagement with the second engagement elements is prevented or limited.

### BRIEF DESCRIPTION OF THE DRAWINGS

The invention will now be more particularly described, by way of example only, with reference to the accompanying drawings, in which:

FIG. 1a shows a top perspective view of a first embodiment of a louver assembly, constructed in accordance with the first aspect of the invention, with one cap element having been removed;

FIG. 1b shows a bottom perspective view of the louver assembly of FIG. 1a, with two cap elements engaged with a louver member;

FIG. 2a shows a cross-section through the louver assembly in a plane parallel to a louver carrier, showing the louver member engaged with the louver carrier without a locking element engaged;

FIG. 2b shows the cross-section of FIG. 2a with the locking element inserted;

FIG. 2c shows the cross-section of FIG. 2b with a cap element engaged with the louver member;

FIG. 3a shows a top plan view of a first embodiment of a louver carrier in accordance with the fourth aspect of the invention;

FIG. 3b shows a top plan view of a second embodiment of a louver carrier with the fourth aspect of the invention;

FIG. 3c shows a side plan view of the louver carrier of FIG. 3a;

FIG. 3d shows a side plan view of the louver carrier of FIG. 3b;

FIG. 4a shows a front perspective view of a first embodiment of the locking element in accordance with the fifth aspect of the invention;

FIG. 4b shows a rear perspective view of the locking element of FIG. 4a;

FIG. 4c shows a top plan view of the locking element of FIG. 4a;

FIG. 4d shows a side plan view of the locking element of FIG. 4a;

FIG. 4e shows a front plan view of the locking element go FIG. 4a; and

FIG. 5 shows a cross-sectional view of a second embodiment of a louver assembly in accordance with the first aspect of the invention.

### DETAILED DESCRIPTION

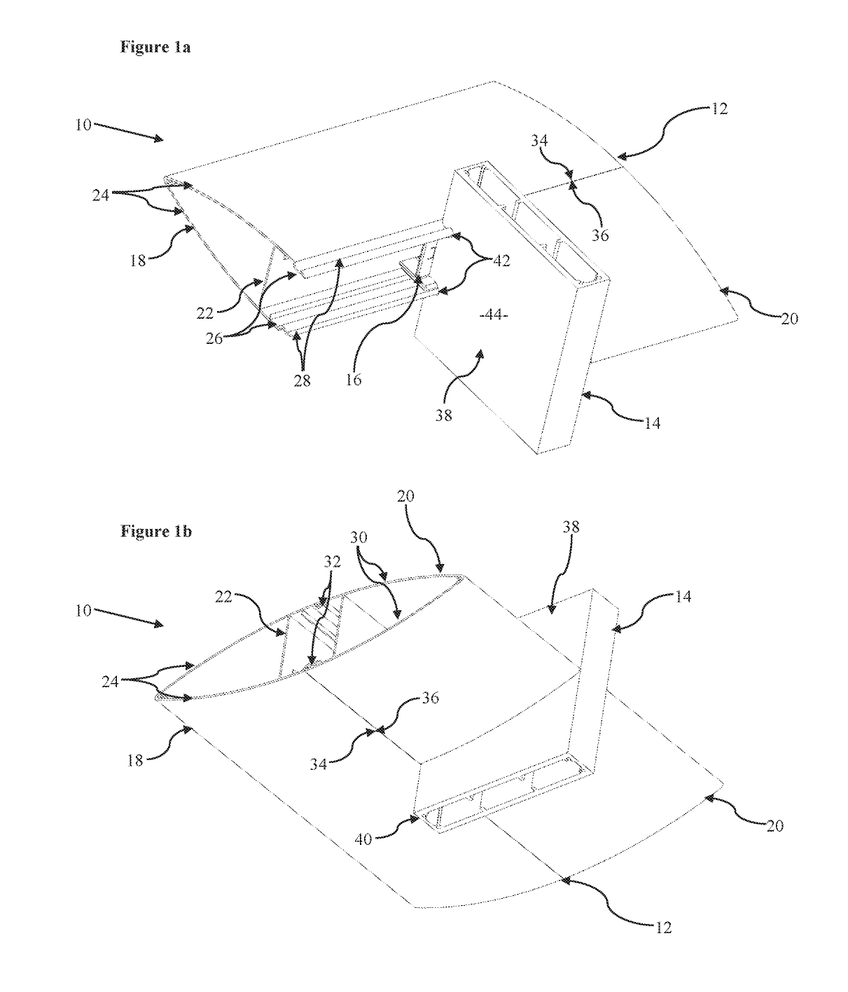

Referring firstly to FIGS. 1a and 1b of the drawings, there is shown a louver assembly, indicated globally at 10, typically used externally for providing shade from the sun to buildings having large glass panels or windows, such that a viewer on the inside of the building has a mostly unobstructed view of the outside, without being affected by the glare of the sun.

The louver assembly 10 comprises a louver 12, a louver carrier 14 to which the louver 12 is mountable, and a locking element 16 which is, in the depicted embodiment, slidably receivable as a tool-less push-fit at least partially within, and in this case fully within, the louver 12. Whilst sliding is the easiest way of engaging the locking element 16 into the louver 12, it will be appreciated that a push-fit or similar mechanism of engagement or engagement means could be utilised. Any appropriate locking mechanism which prevents or limits separation of the louver 12 from the louver carrier 16 could be provided.

The louver 12 itself is an elongate element having a prolate elliptical profile in the depicted embodiment, so as to resemble an aerofoil. This depiction is for illustrative purposes only, and many lateral cross-sectional shapes and sizes of louver are known in the art; elliptic and rectilinear or box-section profiles are amongst the most common designs.

The louver 12 comprises two main longitudinal parts: a louver member 18 which is typically a contiguous elongate member forming the outward-facing portion of the assembled solar shading-assembly 10; and one or more cap elements 20, engagable with the louver member 18 to cover the rear edge thereof and to form a longitudinal rear edge portion of the louver 12. In the embodiment depicted in FIG. 1b, two cap elements 20 are shown, one abutting or substantially abutting either side of the louver carrier 14. It will be apparent that, whilst the cap elements 20 nominally cover the rear edge of the louver member, whether or not the edge is a rear edge will depend upon viewer orientation, and therefore the term rear is intended to be indicative only.

The illustrated louver member 18 is V-shaped or substantially V-shaped in profile, albeit with a reinforcing buttress 22 being provided between the member sides 24 of the louver member 18. Rearwardly of the buttress 22, the sides 24 extend into resiliently deflectable engagement elements 26 having distal portions which form a retaining element, such as a hook or retaining head 28 substantially within the plane of the respective member side 24 from which the deflectable engagement element 26 extends.

Typically, the louver member 18 is constructed from a light metal, such as aluminium, and therefore there will be a natural flexion as the deflectable engagement elements 26 are formed. However, mechanical flexion could be incorporated into the design of the deflectable engagement elements, were they to be constructed from a less flexible material. For example, mechanical flexion could be imparted via a localised thinning of the material used for construction.

Each cap element 20 is also V-shaped or substantially V-shaped in profile, and formed such that complementary upper and lower cap sides 30 meet so as to be flush with the member sides 24 of the louver member 18 when the louver member 18 and cap element 20 are engaged with one another. To this end, at an interior face of each cap side 30 is formed a complementarily shaped cap engagement element 32 which is engagable with the respective deflectable engagement element 26 of the louver member 18.

The retaining heads 28 and cap engagement elements 32 form a preferably snap-fit detent which extends substantially along the longitudinal edges 34, 36 respectively of the sides 24, 30 of the louver member 18 and cap element 20. This ensures a full and complete engagement between the louver member 18 and cap element or elements 20 once assembled into the louver 12. It will be appreciated, however, that any appropriate means of engagement between the two could be utilised, and that such a means of engagement need not extend across the extents of either the louver member or cap element.

The louver carrier 14 comprises a carrier body 38, which is a planar rectilinear block element able to support the entire louver 12. The louver assembly 10 is typically attached to a building via the louver carrier 14, although freestanding assemblies are known. The louver carrier 14 would usually be installed as a support mullion so as to be upright, as illustrated, resulting in substantially horizontally aligned louvers 12 in use, but vertically aligned louvers 12, extending from horizontal louver carriers or transoms 14 are also known, and the louver carrier 14 could feasibly be installed in any orientation in which it could be adequately supported.

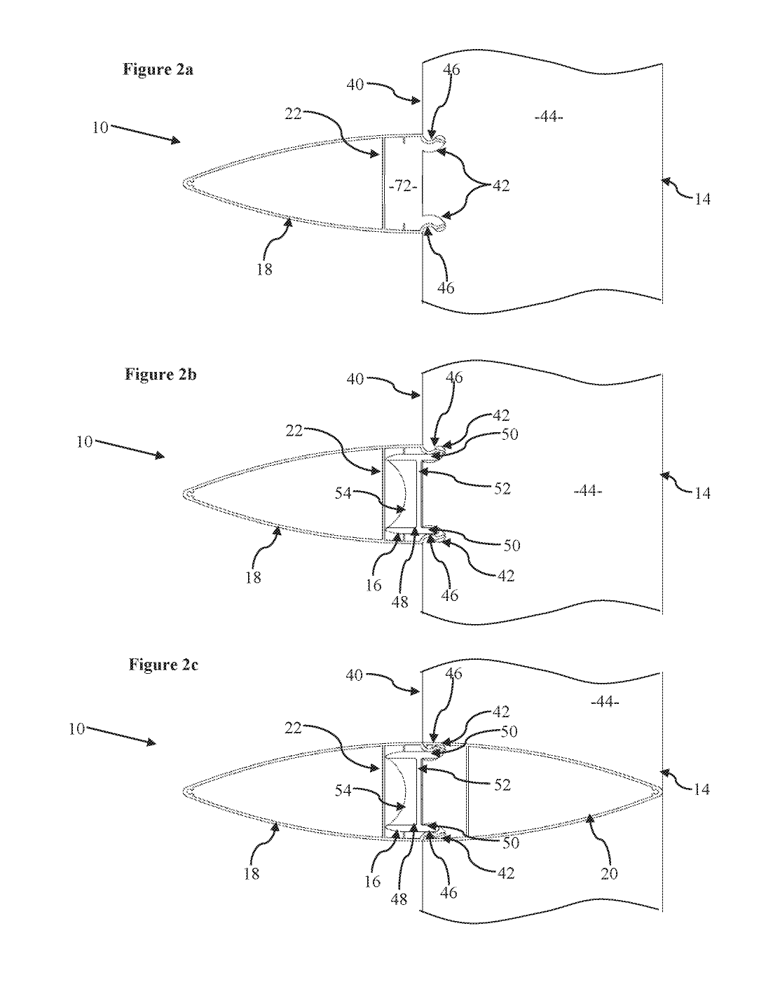

The louver carrier 14 shown in FIGS. 1a to 2c is hollow, so as to reduce the overall weight of the louver assembly 10. Into a front-facing edge 40 of the carrier body 38 are cut two spaced-apart, at least in part non-parallel louver-engagement elements 42, formed as slots which are shaped so as to receive the deflectable engagement elements 26 of the louver member 18, and specifically the retaining head 28 thereof. When viewed from either of the primary planar carrier sides 44, the louver-engagement elements 42 appear as small arcs cut into the louver carrier 14, as can be seen in FIGS. 2a to 2c.

The engagement between the louver member 18 and the louver carrier 14 is specifically shown in FIG. 2a. The deflectable engagement elements 26 of the louver member 18 define a carrier-engagement portion, and the louver-engagement elements 42 define a louver-engagement portion; the carrier- and louver-engagement portions therefore interengage at an engagement interface between the louver member 18 and the louver carrier 14.

Whilst the engagement interface described here is a direct engagement interface between the carrier- and louver-engagement portions, it will be appreciated that the engagement could be provided by using a bracket which is complementarily engagable with both a support mullion and the louver member 18, and therefore there may be an indirect engagement interface between the two. In such a scenario, it will be appreciated that the bracket is acting as or forming part of the louver carrier.

In an unlocked condition, as shown in FIG. 2a, the deflectable engagement elements 26 rest against an inner surface 46 of the louver-engagement elements 42 such that the louver member 18 is received and partially engaged with the louver carrier 14, but in a manner such that the louver member 18 could be relatively easily removed or reinserted.

This may be achieved by sliding the deflectable engagement elements 26 into the louver-engagement elements 42 in a direction parallel to the longitudinal axis of the louver member 18.

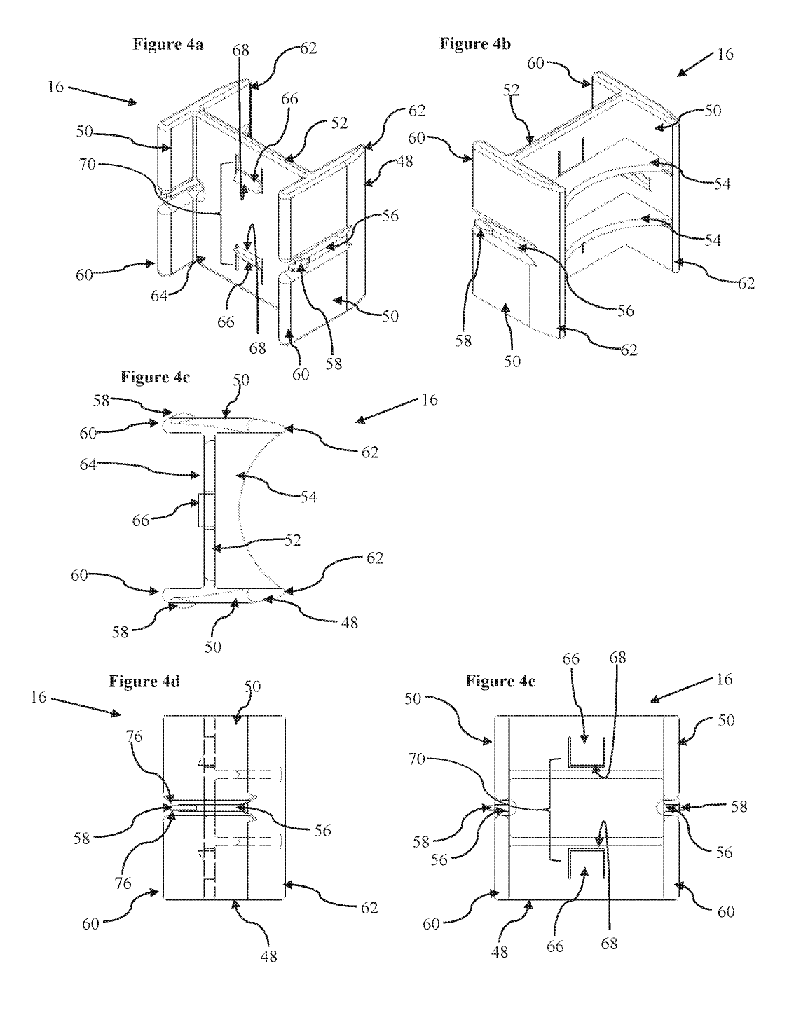

The locking element 16, one embodiment of which can be seen in detail in FIGS. 4a to 4e comprises a substantially H-shaped body portion 48, having two upright side walls 50 which are interconnected by a bridging member 52. Two strengthening portions 54 are also provided to support the structure of the body portion 48 between the two side walls 50, though any number or type of rigidity enhancing structures could be provided.

In each side wall 50, perpendicular to the bridging member 52, a cantilevered tang 56 is preferably positioned. Each tang 56 is positioned primarily within the plane of its respective side wall 50, with the exception of a nub 58 positioned at a distal end of the tang 56 which projects beyond the side wall 50 and therefore beyond the standard volumetric envelope of the body portion 48, as best illustrated in FIG. 4c.

If an orientation of the locking element 16 is defined such that the tang 56 extends in a forwards direction through its respective side wall 50, as shown in FIG. 4a, then front and rear edges 60, 62 respectively of the side wall 50 are defined; these definitions of front and rear edges are, of course, relative, being based upon FIG. 4a, and will be dependent upon the orientation of the locking element 16 in use. The thickness of each side wall 50 is largely uniform at its front edge 60, but tapers inwardly at its rear edge 62.

On a front face 64 of the bridging member 52, there are positioned two opposing projections 66, aligned vertically, that is, perpendicular to the bridging direction of the bridging member 52. The projections 66 define two opposing parallel surfaces 68, extending perpendicularly relative to the front face 64 of the bridging member 52, which thereby form a carrier stop 70.

To assemble the louver assembly 10, the louver member 18 is engaged with the louver carrier 14 in an unlocked condition as described previously, and as shown in FIG. 2a, in which the deflectable engagement elements 26 are in contact with the louver-engagement elements 42 of the louver carrier 14, but without any form of fixed retention.

As can be seen in FIG. 2b, and to some extent in FIG. 1a, the locking element 16 can be inserted into the vacant space 72 formed between the louver carrier 14 and the louver member 18. This space 72 is defined primarily by the buttress 22 of the louver member 18 and the front-facing edge 40 of the carrier body 38.

To insert the locking element 16, it is pushed into the gap between the deflectable engagement elements 26 of the louver member 18, the rear edge 62 entering first; the tapering of the side walls 50 towards their respective rear edges 62 makes this insertion more straightforward, but the tapering is not strictly necessary.

The locking element 16 can then be pushed or slid along the buttress 22 of the louver member 18 towards the engagement interface of the louver member 18 and louver carrier 14, such that the locking element 16 is positioned at or adjacent to the engagement interface. The locking element 16 is sized such that the front face 64 of the bridging member 52 abuts or sits in close proximity to the front-facing edge 40 of the louver carrier 14, with the upper edge 60 of each side wall 50 extending into the louver-engagement elements 42 adjacent the deflectable engagement elements 26.

The upper edges 60 provide a physical barrier to dislocation of the deflectable engagement elements 26 in the louver-engagement elements 42, with the cantilevered tangs 56 being pushed inwardly within the volumetric envelope of the body portion 48. The upper edges 60 of the locking element 16 therefore physically abut the deflectable engagement elements 26, either actively pressing them against the inner surfaces 46 of the louver-engagement elements 42 as a wedge, or merely preventing physical dislocation of the deflectable engagement elements 26 and louver-engagement elements 42, as the deflectable engagement elements 26 are prevented from flexing to release the retaining heads 28. The locking element 16 is therefore interposable between the opposing deflectable engagement elements 26 of the louver member 18 to prevent or limit movement towards each other.

This abutment engagement which locks the deflectable engagement elements 26 in position would most likely be acting as a wedging engagement, but it will be appreciated that an exact or near-exact fit of locking element 16 into the vacant space 72 would prevent dislocation of the deflectable engagement elements 26 from the louver-engagement elements 42 without necessarily providing the sort of perpendicular force associated with a wedge. Abutment engagement is therefore intended to cover both the possibility of the locking element 16 acting as a physical wedge, but alternatively acting as a physical block to dislocation of the first deflectable engagement element or element 26 from engagement with a complementary second engagement element or elements 42.

Once in position, the carrier stop 70 will lock about the carrier body 38 of the louver carrier 18; the parallel surfaces 68 of the projections 66 abut the carrier sides 44 to inhibit and/or prevent perpendicular displacement of the locking element 16, and via the said abutment engagement, the louver member 18, relative to the louver carrier 14.

Depending upon the relative widths of the louver carrier 14 and locking element 16, the locking element 16 may be visible to a greater or lesser extent. The locking element 16 can, at least in part, then be hidden by engaging a cap element 20 with the louver member 18 either side of the louver carrier 14, as illustrated in FIGS. 1b and 2c.

The cap element 20 may therefore be utilised to complete the full visual appearance of the louver 12, though it will be apparent that only the louver member 18 is strictly necessary to complete the abutment engagement to lock the deflectable engagement elements 26 in position. The cap element 20 can therefore also act as a cover to hide the locking element 16 from view, from at least a majority of or all directions, or from at least a normally viewed direction.

The abutment engagement created by the locking element 16 is therefore critical, but not necessarily only achievable as previously illustrated. The or each cantilevered tang 56 may also be dispensed with if creep is not considered to be a problem.

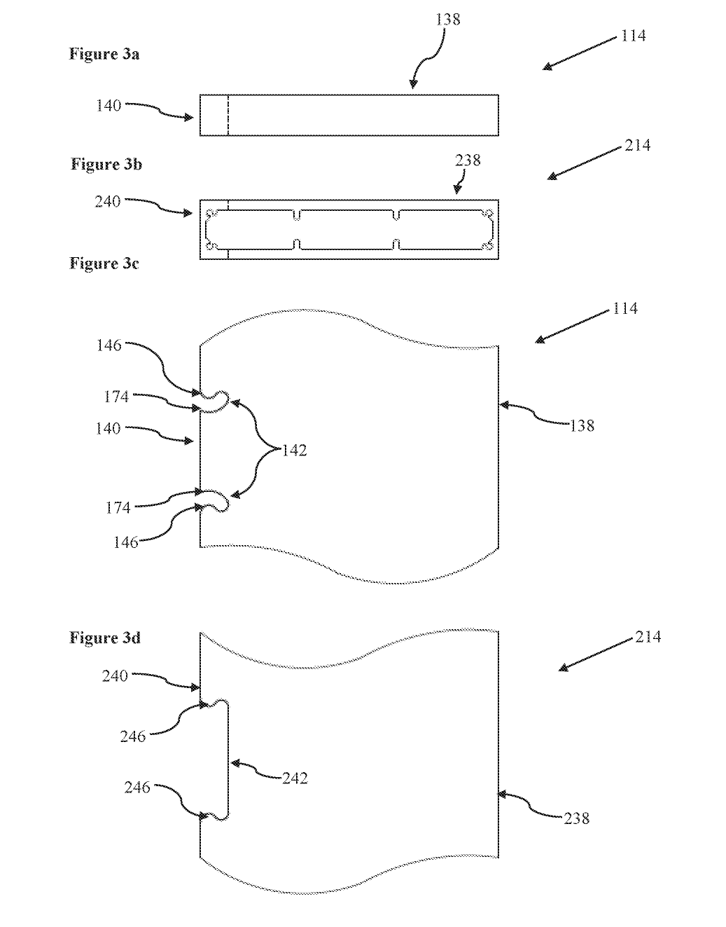

FIGS. 3a and 3c show a second embodiment of a louver carrier 114 and FIGS. 3b and 3d show a third embodiment of a louver carrier 214 which could be used in conjunction with a louver assembly. Identical or similar reference numerals are hereafter used to refer to similar or identical components, and further detailed description is omitted for brevity.

The embodiment illustrated in FIGS. 3a and 3c is almost identical to that shown in FIGS. 2a to 2c; in this instance the louver carrier 114 has a carrier body 138 which is formed from a solid block of material. However, the louver-engagement elements 142 shown cut into the front-facing edge 140 have the same slotted form as those shown in FIGS. 2a to 2c, in that they are largely arcuate and at least in part divergent, having a nominal outer and inner surface 174, 146 of the arc.

The embodiment illustrated in FIGS. 3b and 3d, however, has a carrier body 238 which is hollow, as in the first embodiment of FIGS. 2a to 2c. In this case, there is only provided a single slot or notch 242 provided cut into the front-facing edge 240 of the carrier body 238. The inner surface 246 of the louver-engagement element 242 is formed in a way such that the deflectable engagement elements 26 of a louver member 18 inserted therein would still make contact with the inner surface 246, and the insertion of the locking element 16 would still provide the same barrier to deflection of the deflectable engagement elements 26; the outer surfaces 174 of the second embodiment do not necessarily assist with the abutment engagement if the locking element 16 is sufficiently rigid.

It is therefore not strictly necessary to provide two louver-engagement elements 42, 142 in the louver carrier 14, 114, 214, or even to match the number of louver-engagement elements 42, 142, 242 to the number of deflectable engagement elements 26. The only necessary requirement is that there is engagement at the engagement interface between the louver member 18 and louver carrier 14, regardless of the form of the engagement interface.

This third embodiment of louver carrier 214 illustrates that the form of the locking element could be altered without deviating from the scope of the invention. For example, the locking element could be provided as an elongate bar, extending along or substantially along the longitudinal extent of the louver member 18. Such a bar would provide a physical barrier to prevent flexion of the deflectable engagement elements 26 of the louver member 18, without necessarily providing the perpendicular transfer of force associated with a wedge.

The locking element 16 of the louver assembly shown in FIGS. 1a and 1b are shown in detail in FIGS. 4a to 4e. The cantilevered tangs 56 have thus far not performed any function, flexing out of the way when inserted into a louver member 18. The cantilevered tangs 56 are used as anti-creep spacers in a fully assembled louver assembly in which a plurality of louvers 12 are required in series.

Two louvers 12 or louver members 18 can be installed in series, with one or more louver carriers 14 providing support. However, from both a structural and aesthetic perspective, the best position for a louver carrier 14 providing support to louvers 12 in series is at the intersection between the two louvers 12, such that the louvers 12 project symmetrically from the louver carrier 14.

If the louver members 18 of the louvers 12 are engaged with the louver carrier 14 in approximately the desired positions, the locking element 16 can be inserted at the engagement interface. The carrier stop 70 will lock the locking element 16 relative to the louver carrier 14, and the respective positions of the louver members 18 can then be modified such that the cantilevered tangs 56 of the locking element 16 are permitted to project into their unlocked condition.

The louver members 18 can then be moved into abutment with the outer edges 76 of the cantilevered tangs 56, such that the separation between the louver members 18 is equal to the width of the cantilevered tangs 56, thereby automatically aligning the louvers 12 as a whole to a centreline of the louver carrier 14.

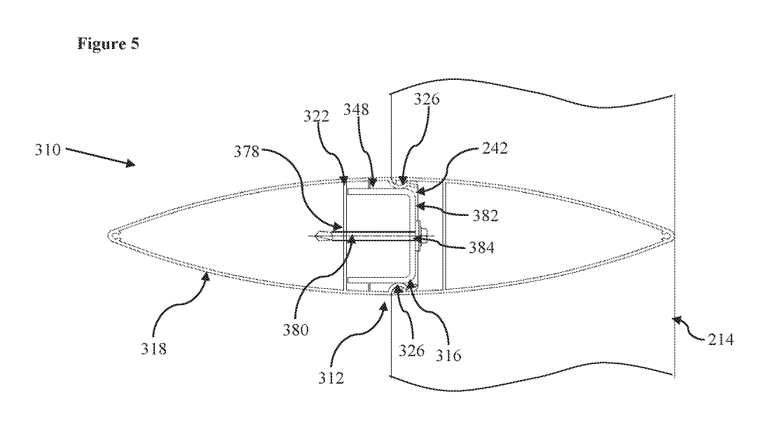

A second embodiment of a louver assembly, indicated globally at 310, is shown in FIG. 5. In this embodiment, there is provided the herebefore-described third embodiment of louver carrier 214 as shown in FIGS. 3b and 3d, having only a single louver-engagement element 242. A louver 312 is also provided in which an aperture 378 is provided in the buttress 322 of the louver member 318. This aperture 378 may be screw-threaded to permit a screw-threaded fastener 380 to be attached thereto.

In this embodiment, the locking element 316 has a body portion 348 which is U-shaped in profile, with the bottom 382 of the ‘U’ being positionable within the louver-engagement element 242 between the deflectable engagement elements 326, with a further aperture 384 being positioned in the bottom 382 to permit the fastener 380 to pass therethrough.

By providing a way of connecting the locking element 316 to the louver member 318, there is a far smaller risk of relative displacement of the louver 312 and louver carrier 214. It will be appreciated that the U-shaped locking element 316 is not the only shape of locking element which would be suitable for use in such an assembly; an O- or D-shaped locking element would work equally well, and such design modifications will be apparent to the skilled person.

It will be apparent that, although the locking element is preferably receivable within the louver member so as to be obscured from view when creating the abutment engagement to lock the deflectable engagement elements, that this is not the only manner in which this could be achieved. For instance, the locking element could be inserted around the outside of the louver member, creating a wedge between the louver member and louver carrier externally. Whilst this may be undesirable aesthetically, this variation could be considered since it may make installation of the louver assembly more straightforward. Other forms of engagement could also be considered without deviating from the core concept of the present invention.

Similarly, whilst the louver assembly has been herebefore described in terms of a deflectable engagement element on the louver assembly being engagable with a recessed louver-engagement element on the louver carrier, it is evidently possible that the reverse is quite feasible. Furthermore, a deflectable engagement element having a retaining head engagable with a recessed louver-engagement element is only one type of connection method which would be suitable for use with deflection engagement of the sort described above. Any complementarily shaped engagement portions on the louver carrier and louver member could therefore be considered.

Again, whilst the maximum number of engaging portions in any of the depicted embodiments is two, that is, two deflectable engagement elements on the louver member and two louver-engagement elements on the louver carrier, this is not definitive, and any number of points of engagement could be provided between the louver member and louver carrier. In particular, it may be possible to provide a louver member as previously described in which only one of the carrier-engagement elements were deflectable, thereby providing a non-deflectable carrier-engagement element towards which the deflectable carrier-engagement may deflect. The relative deflection allows for the louver member to be engaged with the second engagement element on the louver carrier in a similar manner to that as previously described.

As previously discussed, it is possible that a bracket could be provided, to thereby result in indirect engagement between the louver carrier and louver member. For example, a louver carrier may have a louver-engagement portion which is formed as one or more slots, and the louver member may have a carrier-engagement portion which is also formed as one or more slots. A bracket could then be envisaged having a plurality of engagement elements which are each engagable respectively with the louver- and carrier-engagement portions. One or more locking elements could then be received by the bracket to secure the relative positions of the louver carrier and louver member, and thereby limit or prevent movement relative to one another. The present invention is therefore not intended to be limited solely to direct engagement and contact between the louver member and louver carrier.

It is therefore possible to provide a louver assembly comprising a louver carrier, a louver member, and a locking element, in which the louver carrier and louver member directly engage with one another via a deflectable engagement element. The locking element provides abutment engagement to secure the deflectable engagement element in connection with a complementary engagement element, resulting in a louver assembly which can be constructed without the need for specialised tools, or requiring the installation of awkward fastening devices, such as bolts or screws.

As an ancillary benefit, the louver assembly may not require any specific brackets or fastening devices to connect the louver to the louver carrier, which can subsequently reduce the manufacturing cost of the assembly.

Whilst the above-mentioned louver assembly is described as being primarily utilised and attached to an exterior of a building, it will be apparent to the skilled person that such an assembly could readily be provided internal to a building, as a way of protecting the louver assembly from inclement weather, for instance.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention herein described and defined.

1. An exterior louver assembly, the assembly comprising:
a louver carrier;
a louver which is supportable by the louver carrier; and
a locking connector adapted to prevent or limit separation of the louver from the louver carrier, the locking connector including a deflectable first engagement element on one of the louver and the louver carrier, a second engagement element on the other of the louver and the louver carrier and which is engagable with the deflectable first engagement element, and a locking element adapted to prevent or limit movement of the deflectable first engagement element thereby preventing or inhibiting separation of the first and second engagement elements when interconnected.

2. An exterior louver assembly as claimed in claim 1, wherein the deflectable first engagement element is provided on a louver member of the louver, and the second engagement element is provided on the louver carrier.

3. An exterior louver assembly as claimed in claim 2, wherein the deflectable first engagement element is provided at or adjacent to a longitudinal edge of the louver member.

4. An exterior louver assembly as claimed in claim 2, wherein the louver further includes an elongate cap element by which a longitudinal edge of the louver member is coverable.

5. An exterior louver assembly as claimed in claim 1, wherein the louver includes two opposing said deflectable first engagement elements, the two said deflectable first engagement elements being deflectable towards one another during engagement with the second engagement element or elements.

6. An exterior louver assembly as claimed in claim 5, wherein the locking element is receivable between the two said deflectable first engagement elements.

7. An exterior louver assembly as claimed in claim 1, wherein the louver includes one said deflectable first engagement element and one opposing non-deflectable engagement element, the deflectable first engagement element being deflectable towards the non-deflectable first engagement element during engagement with the second engagement element or elements.

8. An exterior louver assembly as claimed in claim 1, wherein the deflectable first engagement element is provided on the louver carrier, and the second engagement element is provided on the louver.

9. An exterior louver assembly as claimed in claim 1, wherein the deflectable first engagement element and the second engagement element are complementarily shaped, the deflectable first engagement element being receivable within the second engagement element.

10. An exterior louver assembly as claimed in claim 1, wherein the louver carrier includes a support mullion or transom to which the louver is directly attachable via the locking connector, or includes a support bracket to which the louver is directly attachable via the locking connector.

11. An exterior louver assembly as claimed in claim 1, wherein the locking element comprises a rigid body portion which in use abuttably engages with and limits deflection of the deflectable first engagement element.

12. An exterior louver assembly as claimed in claim 11, wherein the locking element further comprises a spacer, and wherein the louver assembly comprises a plurality of said louvers, the spacer of the locking element defining a separation between adjacent louvers.

13. An exterior louver assembly as claimed in claim 12, wherein the spacer is formed as a cantilevered tang.

14. An exterior louver assembly as claimed in claim 1, wherein the locking element further comprises a carrier stop against which the louver carrier is abuttable to prevent or limit displacement of the locking element relative to the louver carrier.

15. An exterior louver assembly as claimed in claim 1, wherein the locking element comprises an elongate bar receivable within the louver at or adjacent to the deflectable first engagement element.

16. An exterior louver assembly as claimed in claim 15, wherein the locking element extends across or along at least a majority of a longitudinal extent of the louver.

17. An exterior louver assembly as claimed in claim 1, wherein the locking element is slidably receivable within the louver as a slidable push-fit.

18. A method of assembling a louver assembly, the method comprising the steps of:
providing an exterior louver assembly;
engaging a locking mechanism of the louver assembly such that a deflectable first engagement element of a louver or louver carrier of the assembly is engaged with a second engagement element of the other of the louver or louver carrier; and
inserting a locking element at or adjacent to the deflectable first engagement element to prevent or limit deflection of the deflectable first engagement element, thereby preventing or limiting separation of the deflectable first engagement element and the second engagement element.

19. A method as claimed in claim 18, wherein the locking element of the locking connector is inserted so as to be receivable at least in part within the louver.

20. An exterior louver assembly, the assembly comprising:
a louver carrier which extends from an exterior of a building adjacent to one or more glass panels;
a louver which is supportable by the louver carrier; and
a locking mechanism which prevents or limits separation of the louver from the louver carrier,
wherein the locking mechanism includes at least two vertically spaced-apart deflectable first engagement elements integrally formed as part of the louver,
two vertically spaced-apart non-parallel second engagement elements on the louver carrier and by which the deflectable first engagement elements are push-fit engagable therewith, and
a separate locking element which is slidably interposable between the deflectable first engagement elements to prevent or limit deflection of the deflectable first engagement elements,
so that horizontal extraction of the louver from engagement with the second engagement elements is prevented or limited.
